(19) United States
(12) Patent Application Publication
(10) Pub. No.: US 2026/0066352 A1
(43) Pub. Date: Mar. 5, 2026

(54) ELECTRODE WETTING APPARATUS

(71) Applicant: SAMSUNG SDI CO., LTD., Yongin-Si Gyeonggi-do (KR)

(72) Inventor: Hyeonseo SONG, Yongin-Si (KR)

(21) Appl. No.: 19/068,850

(22) Filed: Mar. 3, 2025

(30) Foreign Application Priority Data
Sep. 5, 2024 (KR) 10-2024-0120608

(51) Int. Cl. H01M 10/058; H01F 1/44

(52) U.S. Cl. CPC H01M 10/058; H01F 1/447

(57) ABSTRACT

An electrolyte wetting apparatus includes a first mold configured to wrap a case of a secondary battery, an interior of the case accommodating an electrode assembly and an electrolyte that impregnates the electrode assembly; a magnetorheological fluid configured to wrap the first mold; and a magnetic field application device configured to apply a time-varying magnetic field to the magnetorheological fluid so that the secondary battery vibrates.

### CROSS REFERENCE TO RELATED APPLICATION

The present application claims priority to and the benefit of Korean Application No. 10-2024-0120608, filed on Sep. 5, 2024, in the Korean Intellectual Property Office, the entire disclosure of which is incorporated herein by reference.

### BACKGROUND

### 1. Field

Aspects of the present disclosure relate to an electrolyte wetting apparatus.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

In general, a secondary battery is manufactured by placing the electrode assembly in a case and then injecting an electrolyte solution into the case. The secondary battery is then stored to allow the injected electrolyte to sufficiently wet the electrode assembly, which is referred to as an aging process. The aging process of the related art may take an extended period of time of about three days, thereby slowing down the manufacturing rate of secondary batteries.

The above information disclosed in this Background section is for enhancement of understanding of the background of the present disclosure, and therefore, it may contain information that does not constitute related (or prior) art.

### SUMMARY

Aspects of some embodiments of the present disclosure are directed to an electrolyte wetting apparatus for solving the problems described above.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

According to some embodiments of the present disclosure, there is provided an electrolyte wetting apparatus including: a first mold configured to wrap a case of a secondary battery, an interior of the case accommodating an electrode assembly and an electrolyte that impregnates the electrode assembly; a magnetorheological fluid configured to wrap the first mold; and a magnetic field application device configured to apply a time-varying magnetic field to the magnetorheological fluid so that the secondary battery vibrates.

In some embodiments, the magnetorheological fluid includes a plurality of magnetic particles and an oil in which the magnetic particles are dispersed.

In some embodiments, the magnetic particles include a plurality of carbonyl iron particles (CIPs), and the oil includes at least one of non-magnetic silicone oil or non-magnetic mineral oil.

In some embodiments, the magnetic field application device includes: a support configured to support the secondary battery, the first mold, and the magnetorheological fluid; a permanent magnet on a side opposite the magnetorheological fluid relative to the support and configured to apply the time-varying magnetic field to the magnetorheological fluid to deform the magnetorheological fluid; and a second mold configured to hold the permanent magnet.

In some embodiments, the magnetic field application device further includes a controller connected to the second mold and configured to control movement of the second mold to vary a strength or a direction of the time-varying magnetic field applied to the magnetorheological fluid.

In some embodiments, the second mold is formed from a non-magnetic material.

In some embodiments, the first mold is formed from a non-magnetic and non-conductive material.

In some embodiments, the first mold is formed from an elastic material.

In some embodiments, a surface of the first mold has a roughness at or above a set value.

In some embodiments, the secondary battery is a pouch lithium ion secondary battery.

According to some embodiments of the present disclosure, there is provided an electrolyte wetting apparatus including: a first mold configured to wrap a case of a secondary battery, an interior of the case accommodating an electrode assembly and an electrolyte that impregnates the electrode assembly; a magnetorheological fluid configured to wrap the first mold; a magnetic field application device configured to apply a magnetic field to the magnetorheological fluid so that the secondary battery vibrates in response to deformation of the magnetorheological fluid; and a controller connected to the magnetic field application device and configured to control current applied to the magnetic field application device to vary a strength or a direction of the magnetic field applied to the magnetorheological fluid.

In some embodiments, the magnetic field application device includes: a frame; a magnetic field generator mounted on the frame and including an electromagnetic induction coil configured to generate the magnetic field; and an operating portion positioned on a central portion of the frame and on which the secondary battery, the first mold, and the magnetorheological fluid are positioned.

In some embodiments, the magnetic field generator includes: a first set of solenoids including a plurality of first solenoids spaced apart a distance from the operating portion on a virtual plane including the operating portion and positioned symmetrically about the operating portion; and a second set of solenoids including a plurality of second solenoids on a first side relative to the virtual plane to be directed toward the operating portion in common.

In some embodiments, the magnetic field generator includes: a first set of solenoids including a plurality of first solenoids spaced apart a distance from the operating portion and on opposite sides of the operating portion in a first direction; and a second set of solenoids including a plurality of second solenoids spaced apart a distance from the operating portion and on opposite sides of the operating portion in a second direction different from the first direction.

In some embodiments, the magnetic field generator includes: a first set of solenoids including a plurality of first solenoids positioned on a first side relative to a virtual plane including the operating portion and directed toward the operating portion in common; and a second set of solenoids including a plurality of second solenoids positioned on a second side relative to the virtual plane and directed toward the operating portion in common.

In some embodiments, the magnetic field generator includes a plurality of solenoids spaced apart a distance from the operating portion and positioned radially about the operating portion.

In some embodiments, the magnetic field generator includes three-axis Helmholtz coils spaced apart a distance from the operating portion.

In some embodiments, the first mold is formed from a non-magnetic and non-conductive material.

In some embodiments, a surface of the first mold has a roughness at or above a set value.

In some embodiments, the magnetorheological fluid includes a plurality of magnetic particles and an oil in which the magnetic particles are dispersed.

According to some embodiments of the present disclosure, due to the fluidity imparted to an electrolyte in a secondary battery, the electrolyte may provide uniform wetting and the wetting rate may be improved.

According to some embodiments of the present disclosure, vibrating the electrolyte through the magnetorheological fluid may maintain thermal stability, thereby improving the longevity of the secondary battery.

According to some embodiments of the present disclosure, the electrolyte wetting process may be improved (e.g., optimized) regardless of the type of secondary battery by setting various conditions such as vibration frequency, the direction and strength of the applied magnetic field, the magnetorheological fluid material, and the like according to the size, material, and design of the secondary battery.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates an electrolyte wetting apparatus according to some embodiments of the present disclosure.

FIG. 2 illustrates the secondary battery according to some embodiments of the present disclosure.

FIGS. 3A-3B respectively illustrate a structure of the magnetorheological fluid without and with an applied magnetic field, according to some embodiments of the present disclosure.

FIG. 3C illustrates characteristics of the magnetorheological fluid according to some embodiments of the present disclosure.

FIGS. 4A-4B respectively illustrate an electrolyte wetting apparatus 400 and its constituent magnetic field generator, according to some embodiments of the present disclosure.

FIG. 5 illustrates a magnetic field generator according to some embodiments of the present disclosure.

FIG. 6 illustrates a magnetic field generator according to some embodiments of the present disclosure.

FIG. 7 illustrates an electromagnetic device according to some embodiments of the present disclosure.

FIG. 8 illustrates an electromagnetic device according to some embodiments of the present disclosure.

FIG. 9 illustrates an electromagnetic device according to some embodiments of the present disclosure.

FIG. 10 illustrates a flowchart showing an electrolyte wetting method according to some embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements. In addition, it will be understood that when a component is referred to as being “linked,” “coupled,” or “connected” to another component, the elements may be directly “coupled,” “linked” or “connected” to each other, or another component may be “interposed” between the components”.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

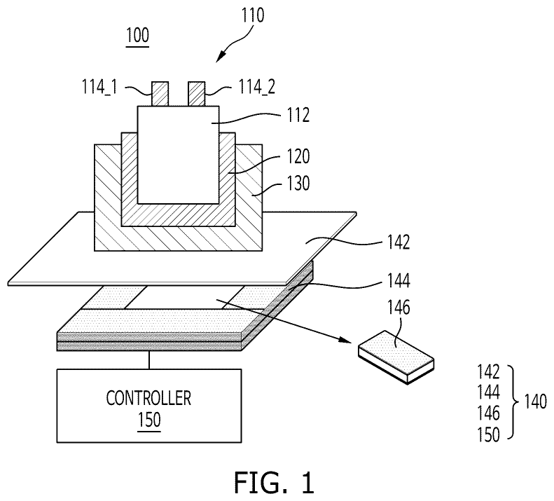

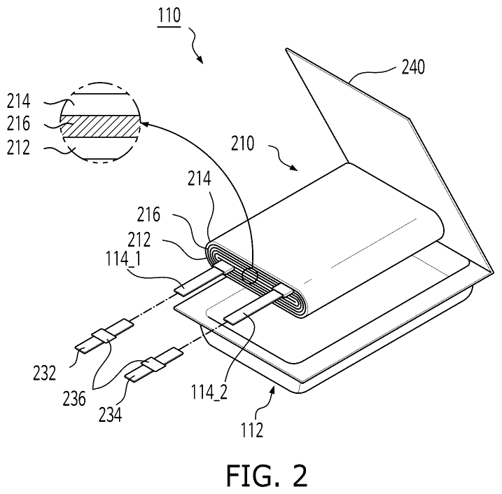

FIG. 1 illustrates an electrolyte wetting apparatus 100 according to some embodiments of the present disclosure. Referring to FIG. 1, the electrolyte wetting apparatus 100 according to some embodiments of the present disclosure may include a first mold 120 configured to wrap a case 112 of a secondary battery 110, a magnetorheological fluid 130 disposed (e.g., positioned/located) to wrap the first mold 120, and a magnetic field application device 140 configured to apply a time-varying magnetic field to the magnetorheological fluid 130 so that the secondary battery 110 vibrates. Here, the interior of the case 112 of the secondary cell 110 may accommodate an electrode assembly and an electrolyte with which the electrode assembly is wet. A detailed configuration of the secondary battery 110 is described further below with reference to FIG. 2. A detailed configuration of the secondary battery 110 will be described later with reference to FIG. 2.

In some embodiments, the first mold 120 may be configured to wrap around the case 112 of the secondary battery 110. The first mold 120 may have a receiving space with an open first end, and a portion of the case 112 of the secondary battery 110 may be inserted into the receiving space of the first mold 120. Accordingly, the first mold 120 may be configured to wrap around the case 112 of the secondary battery 110. Here, the first mold 120 and the case 112 may be in contact with each other. The first mold 120 may be configured to be spaced apart at least a set or predetermined distance from the first electrode tab 114_1 and the second electrode tab 114_2 of the secondary battery 110 and to wrap around the case 112 of the secondary battery 110. In other words, the first mold 120 may be configured to not wrap around the first electrode tab 114_1 and the second electrode tab 114_2. The first mold 120 may prevent the magnetorheological fluid 130 from contacting the case 112 so that the case 112 is not contaminated.

In some embodiments, the first mold 120 may be formed from a non-magnetic material so as not to be affected by a magnetic field applied by the magnetic field application device 140. The first mold 120 may be formed from a non-conductive material so as not to electrically affect the secondary battery 110. The first mold 120 may be formed from a non-magnetic and non-conductive material. The first mold 120 may be formed from an elastic material, such as rubber, to efficiently transmit vibrations to the secondary battery 110, and may be in contact with the secondary battery 110.

In some embodiments, the outer circumferential surface and the inner circumferential surface of the first mold 120 may have different shapes. The outer circumferential surface of the first mold 120 may have a spherical shape, a cylindrical shape, a rectangular parallelepiped shape, or the like, or may have an irregular shape without a specific shape. The surface of the outer circumferential surface of the first mold 120 may have a roughness at or above a set or predetermined value. For example, the surface of the outer circumferential surface of the first mold 120 may have microscopic protrusions. Because the surface of the outer circumferential surface of the first mold 120 has a roughness at or above a set or predetermined value, the surface area in contact with the magnetorheological fluid 130 may be increased, so that vibrations may be effectively transmitted to the secondary battery 110.

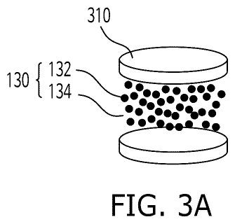

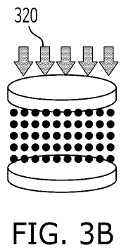

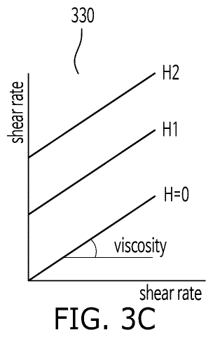

In some embodiments, the magnetorheological fluid 130 may include a plurality of magnetic particles and an oil in which the magnetic particles are dispersed. Here, the magnetic particles may include a plurality of carbonyl iron particles (CIPs), and the oil may include at least one of non-magnetic silicone oil or non-magnetic mineral oil. Based on the deformation of the magnetorheological fluid 130 in response to an external magnetic field applied thereto, the secondary battery 110 may vibrate, thereby increasing the wetting rate of the electrolyte. For example, the magnetorheological fluid 130 may change the properties or shape thereof by immediately responding to the applied external magnetic field and return to the original state in response to the applied external magnetic field being removed. Accordingly, the properties or shape of the magnetorheological fluid 130 may be continuously modified by repeatedly applying and removing an external magnetic field to and from the magnetorheological fluid 130 or by continuously changing the strength or direction of the magnetic field after the application of the external magnetic field. The resulting movement of the magnetorheological fluid 130 may have a result similar to the application of vibration to the secondary battery 110. A detailed description of the magnetorheological fluid 130 is provided further below with reference to FIGS. 3A-3C.

In some embodiments, the magnetic field application device 140 may include: a support 142 configured to support the secondary battery 110, the first mold 120, and the magnetorheological fluid 130; a permanent magnet 146 disposed on a side opposite the magnetorheological fluid 130 relative to the support 142 and configured to apply a magnetic field to the magnetorheological fluid 130 to deform the magnetorheological fluid 130, and a second mold 144 configured to hold the permanent magnet 146. The support 142 may support the secondary battery 110, the first mold 120, and the magnetorheological fluid 130, and may separate the magnetorheological fluid 130 and the permanent magnet 146.

The permanent magnet 146 may include any magnetic material that applies a magnetic field. For example, the permanent magnet 146 may include at least one of NdFeB or SmCo. The magnetorheological fluid 130 may be deformed depending on the strength or direction of the magnetic field applied by the permanent magnet 146, and vibrations may be applied to the secondary battery 110 accordingly. The second mold 144 may include a fixing portion configured to hold the permanent magnet 146 therein. The second mold 144 may be formed from a non-magnetic material. The second mold 144 may hold the permanent magnet 146 to prevent the permanent magnet 146 from sticking to other components during the electrolyte wetting process.

In some embodiments, the magnetic field application device 140 may further include a controller 150 connected to the second mold 144 and configured to control movement of the second mold 144 to vary the strength or direction of the magnetic field applied to the magnetorheological fluid 130. The controller 150 may be a mechanical or electronic control device. For example, the controller 150 may include a gripper that holds the second mold 144 and is height-adjustable. For example, the controller 150 may include a motor to rotate the second mold 144. However, the controller 150 is not limited thereto, and may be any mechanical or electronic device capable of repositioning or rotating the second mold 144. For example, the controller 150 may include a gripper and a motor. As the second mold 144 is repositioned or rotated by the controller 150, the permanent magnet 146 fixed to the second mold 144 may be repositioned or rotated. Accordingly, the intensity or direction of the magnetic field applied to the magnetorheological fluid 130 may be varied over time, thereby deforming the shape or properties of the magnetorheological fluid, and this deformation may cause vibration to be applied to the secondary battery 110, thereby imparting fluidity to the electrolyte. Due to fluidity imparted to the electrolyte in the secondary battery 110, the electrolyte may provide uniform wetting and the wetting rate may be improved (e.g., increased).

FIG. 2 illustrates the secondary battery 110 according to some embodiments of the present disclosure. Referring to FIG. 2, the secondary battery 110 according to some embodiments of the present disclosure may include the case 112 and an electrode assembly 210 disposed inside the case 112.

The electrode assembly 210 may include a first electrode 212, a second electrode 214, and a separator 216 provided between the first and second electrodes 212 and 214. After the separator 216, which is an insulator, is disposed between the first electrode 212 and the second electrode 214, the first electrode 212 and the second electrode 214 may be wound. In the electrode assembly 210, the first electrode 212 may serve as a negative electrode, the second electrode 214 may serve as a positive electrode, or vice versa.

The first electrode 212 may be formed by applying an active material, such as graphite or carbon, to a substrate formed of a metal foil, such as copper, copper alloy, nickel, or nickel alloy, and may include an uncoated portion, which is a region where the active material is not applied. The first electrode tab 114_1 may be connected to the uncoated portion of the first electrode 212. The first electrode tab 114_1 may be a current flow path between the first electrode 212 and the first lead tab 232. The first lead tab 232 may have a tab film 236 attached thereto for insulation from (e.g., for achieving electrical insulation from) the case 112.

The second electrode 214 may be formed by applying an active material, such as a transition metal oxide, to a substrate formed of a metal foil, such as aluminum or an aluminum alloy, and may include an uncoated portion, which is a region where the active material is not applied. The second electrode tab 114_2 may be connected to the uncoated portion of the second electrode 214. The second electrode tab 114_2 may be a current flow path between the second electrode 214 and the second lead tab 234. The second lead tab 234 may have a tab film 236 attached thereto for insulation from (e.g., for achieving electrical insulation from) the case 112.

The separator 216 functions to prevent short-circuiting of the first electrode 212 and the second electrode 214 while allowing lithium ions to migrate. The separator 216 may be formed from, for example, a polyethylene film, a polypropylene film, a polyethylene-polypropylene film, and/or the like.

The case 112 may form the overall contour of the secondary battery 110, and may be formed from a conductive metal such as aluminum, an aluminum alloy, or nickel-plated steel. In addition, the case 112 may provide a space in which the electrode assembly 210 is accommodated.

According to some embodiments of the present disclosure, the secondary battery 110 may include a sealing portion 240. The secondary battery 110 may be manufactured by sealing the case 112 with the sealing portion 240 after the electrode assembly 210 and the electrolyte are inserted into the case 112. For example, the case 112 may be seal with the sealing portion 240 by methods such as welding or thermal fusion. In such examples, the sealing portion 240 may be a component included in the case 112.

In FIG. 2, the secondary battery 110 is shown as a pouch secondary battery, but the scope of the present disclosure is not limited thereto. For example, the secondary battery 110 may be a secondary battery of any shape, such as a prismatic battery, a cylindrical battery, or the like. The secondary battery 110 may also be a lithium-ion secondary battery, a sodium-ion secondary battery, or the like. However, the scope of the present disclosure is not limited thereto, and the secondary battery 110 includes any battery capable of repeatedly providing electricity by charging and discharging.

The secondary battery 110 according to some embodiments of the present disclosure may be applied to automobiles, cell phones, and/or various other electrical devices, and the present disclosure is not limited thereto.

FIGS. 3A-3B respectively illustrate a structure of the magnetorheological fluid without and with an applied magnetic field, according to some embodiments of the present disclosure. FIG. 3C illustrates characteristics of the magnetorheological fluid according to some embodiments of the present disclosure.

Referring to FIGS. 3A-3B, the magnetorheological fluid 130 in the container 310 according to some embodiments of the present disclosure may include a plurality of magnetic particles 132 formed from a ferromagnetic or paramagnetic material and an oil 134 in which the magnetic particles 132 are dispersed. In examples in which an external magnetic field 320 is not applied, the magnetorheological fluid 130 may flow like a fluid in a disordered state (e.g., a fluid in a state similar to a Newtonian fluid) in which the magnetic particles 132 are randomly dispersed due to a low viscosity. In examples in which the external magnetic field 320 is applied to the magnetorheological fluid 130, the magnetic particles 132 may align in the direction of the magnetic field 320 to increase the viscosity and the shear stress of the fluid and achieve the properties of semi-solid materials, thereby resulting in a change in the shape or properties.

The magnetic particles 132 may be formed from any material having low coercivity and high saturation magnetization, such as a plurality of carbonyl iron particles (CIPs) or the like. The magnetic particles 132 may also include any ferromagnetic material, such as an iron-cobalt alloy, a nickel-zinc alloy, a ceramic alloy, or any paramagnetic material, such as iron carbonyl, magnetite, maghemite, or chromium. The magnetic particles 132 are not limited to the materials described above, and may include any ferromagnetic or paramagnetic material.

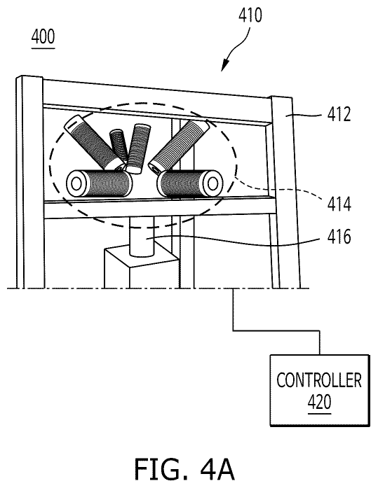

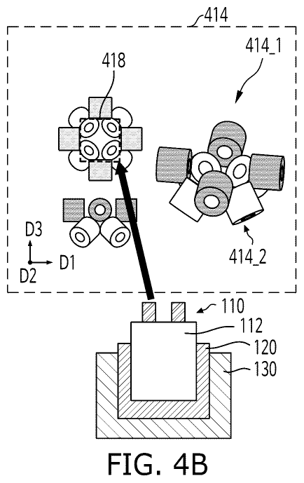

The oil 134 may include at least one of a non-magnetic silicone oil or a non-magnetic mineral oil. The magnetic field 320 may be applied by, for example, the magnetic field application device 140 of the electrolyte wetting apparatus 100 shown in FIG. 1 or an electromagnetic device 410 of the electrolyte wetting apparatus 400 shown in FIG. 4A.

Referring to FIG. 3C, graph 330 illustrates the relationship between shear rate and shear stress as a function of shear flow in examples in which the magnetic field 320 is applied to the magnetorheological fluid 130. According to the graph 330, in examples in which the strength of the applied magnetic field 320 is stronger, the shear stress applied to the magnetorheological fluid 130 may be greater for the same shear rate. For example, in examples in which different intensities of the magnetic field 320 are referred to as first intensity H1 and second intensity H2, respectively, the second intensity H2 may be greater than the first intensity H1, and accordingly the shear stress applied to the magnetorheological fluid 130 may be greater. The viscosity of the magnetorheological fluid 130 may be defined as the ratio of the shear rate to the shear stress.

According to some embodiments, changes in the shape or properties of the magnetorheological fluid 130 may be continuously controlled by adjusting the strength or direction of the magnetic field 320 applied externally. For example, in examples in which the strength of the external magnetic field 320 is greater, the viscosity of the magnetorheological fluid 130 may be higher, and in examples in which the external magnetic field 320 is removed, the magnetorheological fluid 130 may return to a disordered fluid-like state. In other words, the properties or shape of the magnetorheological fluid 130 may be deformed in immediate response to the strength or direction of the applied external magnetic field 320, and may return to the original state in examples in which the external magnetic field 320 is removed. In examples in which applying a magnetic field 320 having a second intensity H2 is followed by applying a magnetic field having a first intensity H1 or removing the applied magnetic field 320, the magnetorheological fluid 130 may move like a fluid having a lower viscosity, thereby causing an object wetted with or embedded in the magnetorheological fluid 130 to vibrate. That is, repeatedly applying and removing the external magnetic field 320 to and from the magnetorheological fluid 130, or applying the external magnetic field 320 and then continuously changing the strength or direction of the magnetic field may continuously modify the properties or shape of the magnetorheological fluid 130, and the resulting movement of the magnetorheological fluid 130 may cause a result similar to the application of vibration to an object wetted with or embedded in the magnetorheological fluid 130.

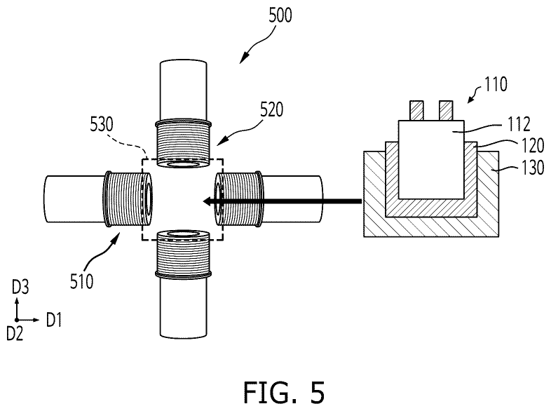

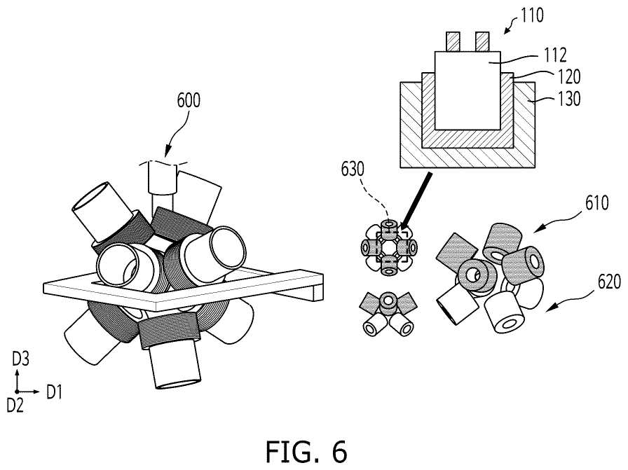

FIGS. 4A-4B respectively illustrate an electrolyte wetting apparatus 400 and its constituent magnetic field generator, according to some embodiments of the present disclosure. FIG. 5 illustrates a magnetic field generator 500 according to some embodiments of the present disclosure. FIG. 6 illustrates a magnetic field generator 600 according to some embodiments of the present disclosure.

Referring now to FIGS. 4A-4B, an electrolyte wetting apparatus 400 according to some embodiments of the present disclosure includes: a first mold 120 configured to wrap a case 112 of a secondary battery 110; a magnetorheological fluid 130 disposed to wrap the first mold 120; an electromagnetic device 410 configured to apply a magnetic field to the magnetorheological fluid 130 such that the secondary battery 110 is vibrated by deformation of the magnetorheological fluid 130; and a controller 420 connected to the electromagnetic device 410 and configured to control a current applied to the electromagnetic device 410 to vary the strength or direction of the magnetic field applied to the magnetorheological fluid 130. Herein, the interior of the case 112 may accommodate an electrode assembly and an electrolyte with which the electrode assembly is wetted. Descriptions of the secondary battery 110, the first mold 120, and the magnetorheological fluid 130, which are the same as those of FIGS. 1 to 3, may not be repeated here.

In some embodiments, the electromagnetic device 410 may include: a frame 412; a magnetic field generator 414 mounted on the frame 412 and including an electromagnetic induction coil configured to generate a magnetic field; and an operating portion 418 positioned on the central portion of the frame 412 and on which the secondary battery 110, the first mold 120, and the magnetorheological fluid 130 are disposed. In some embodiments, the electromagnetic device 410 may further include a support 416 configured to support the magnetic field generator 414. The frame 412 may have the magnetic field generator 414 disposed in the internal cavity thereof. The frame 412 may be formed from a metallic material, such as, for example, stainless steel, aluminum, or the like. The frame 412 may support the secondary battery 110, the first mold 120, and the magnetorheological fluid 130 disposed on the magnetic field generator 414 and the operating portion 418, in addition to the support 416 disposed in the interior cavity of the frame 412.

In some embodiments, the magnetic field generator 414 may further include: a first set of solenoids 414_1 including a plurality of first solenoids spaced apart a set or predetermined distance from the operating portion 418 on a virtual plane including the operating portion 418 and disposed symmetrically about the operating portion 418; and a second set of solenoids 414_2 including a plurality of second solenoids disposed on a first side relative to the virtual plane to be directed toward the operating portion 418 in common.

For example, the first set of solenoids 414_1 may be spaced apart a set or predetermined distance from the operating portion 418, and include two first solenoids disposed on opposite sides of the operating portion 418 in a first direction D1, respectively, and two first solenoids disposed on opposite sides of the operating portion 418 in a second direction D2 perpendicular to the first direction D1, respectively. The second set of solenoids 414_2 may be spaced apart a set or predetermined distance from the operating portion 418, and include four second solenoids disposed at positions corresponding to corners of side surfaces of a virtual square horn with the operating portion 418 as a common vertex. However, the present disclosure is not limited thereto, and the number and arrangement of solenoids included in each of the first set of solenoids 414_1 and the second set of solenoids 414_2 may be modified variously in any suitable manner.

The controller 420 may independently control the current applied to the solenoids included in the first set of solenoids 414_1 and the second set of solenoids 414_2. Due to this characteristic configuration, the strength or direction of the magnetic field applied to the magnetorheological fluid 130 disposed on the operating portion 418 may be precisely controlled.

Referring now to FIG. 5, the magnetic field generator 500 according to some embodiments of the present disclosure may replace the magnetic field generator 414 included in the electromagnetic device 410 disclosed with reference to FIG. 4A. In some embodiments, the magnetic field generator 500 may include: a first set of solenoids 510 including a plurality of first solenoids spaced apart a set or predetermined distance from an operating portion 530 and disposed on opposite sides of the operating portion 530 in the first direction D1, respectively; and a second set of solenoids 520 including a plurality of second solenoids spaced apart a set or predetermined distance from the operating portion 530 and disposed on opposite sides of the operating portion 530 in a second direction D3 different from the first direction D1, respectively. However, the present disclosure is not limited thereto, and the number and arrangement of solenoids included in each of the first set of solenoids 510 and the second set of solenoids 520 may be modified variously in any suitable manner.

Referring now to FIG. 6, the magnetic field generator 600 according to some embodiments of the present disclosure may replace the magnetic field generator 414 included in the electromagnetic device 410 disclosed reference to FIG. 4A. In some embodiments, the magnetic field generator 600 may include: a first set of solenoids 610 including a plurality of first solenoids positioned on a first side relative to a virtual plane including the operating portion 630 and disposed to be directed toward the operating portion 630 in common; and a second set of solenoids 620 including a plurality of second solenoids positioned on a second side relative to the virtual plane and disposed to be directed toward the operating portion 630 in common.

For example, the first set of solenoids 610 may include four first solenoids spaced apart a set or predetermined distance from the operating portion 630 and disposed at positions corresponding to corners of side surfaces of the virtual square cone with the operating portion 630 as a common vertex. The second set of solenoids 620 may also include four second solenoids spaced apart a set or predetermined distance from the operating portion 630 and disposed at positions corresponding to corners of side surfaces of the square cone of the virtual with the operating portion 630 as a common vertex. The square horn of the virtual corresponding to the first set of solenoids 620 and the square horn of the virtual corresponding to the second set of solenoids 620 may be positioned opposite each other while sharing the vertex. In some embodiments, the second set of solenoids 620 may be disposed symmetrically with respect to the first set of solenoids 610 about an axis of symmetry directed in a second direction D3 different from the first direction D1.

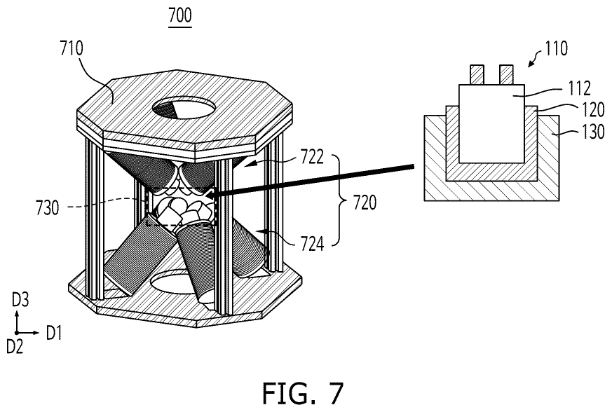

FIG. 7 illustrates an electromagnetic device 700 according to some embodiments of the present disclosure. Referring to FIG. 7, the electromagnetic device 700 according to some embodiments of the present disclosure may replace the electromagnetic device 410 included in the electrolyte wetting apparatus 400 disclosed reference to FIG. 4A.

The electromagnetic device 700 may include: a frame 710; a magnetic field generator 720 disposed on the frame 710 and including an electromagnetic induction coil configured to generate a magnetic field; and an operating portion 730 positioned on the central portion of the frame 710 and on which the secondary battery 110, the first mold 120, and the magnetorheological fluid 130 are disposed. The frame 710 may have a magnetic field generator 720 provided in the internal cavity thereof. The frame 710 may be formed from, for example, a metallic material, such as stainless steel, aluminum, or the like, or a combination of a metallic material and a polymer. The frame 710 may support the secondary battery 110, the first mold 120, and the magnetorheological fluid 130, which are disposed on the magnetic field generator 720 and the operating portion 730.

In some embodiments, the magnetic field generator 720 may include: a first set of solenoids 722 including a plurality of first solenoids positioned on a first side relative to a virtual plane including the operating portion 730 and disposed to be directed toward the operating portion 730 in common; and a second set of solenoids 724 including a plurality of second solenoids positioned on a second side relative to the virtual plane and disposed to be directed toward the operating portion 730 in common. In some other embodiments, the magnetic field generator 720 may include: a first set of solenoids 722 spaced apart a set or predetermined distance from the operating portion 730 or disposed in a shape corresponding to corners of side surfaces of a square cone in a first direction D1 with a virtual point formed at a position on the operating portion 730 as a common vertex; and a second set of solenoids 724 spaced apart a set or predetermined distance from the operating portion 730 and disposed symmetrically with respect to the first set of solenoids 722 about an axis of symmetry directed in a second direction D3 different from the first direction D1.

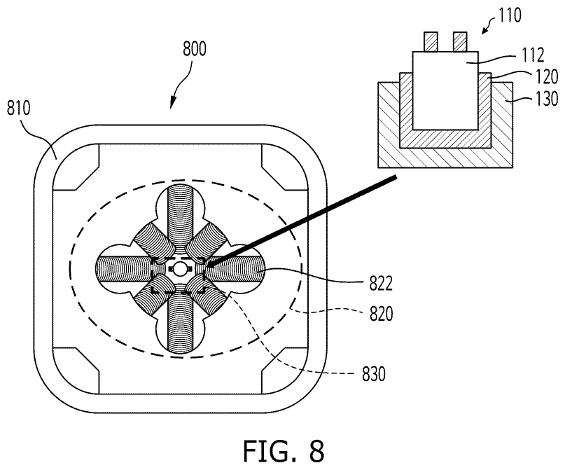

FIG. 8 illustrates an electromagnetic device 800 according to embodiments of the present disclosure. Referring to FIG. 8, the electromagnetic device 800 according to some embodiments of the present disclosure may replace the electromagnetic device 410 included in the electrolyte wetting apparatus 400 disclosed reference to FIG. 4A.

The electromagnetic device 800 may include: a frame 810; a magnetic field generator 820 disposed on the frame 810 and including an electromagnetic induction coil configured to generate a magnetic field; and an operating portion 830 positioned on the central portion of the frame 810 and on which the secondary battery 110, the first mold 120, and the magnetorheological fluid 130 are disposed. The frame 810 may have a magnetic field generator 820 disposed in the internal cavity thereof. The frame 810 may be formed from, for example, a metallic material, such as stainless steel, aluminum, or the like, or a combination of a metallic material and a polymer. The frame 810 may accommodate in the cavity thereof the secondary battery 110, the first mold 120, and the magnetorheological fluid 130, which are disposed on the magnetic field generator 820 and the operating portion 830.

In some embodiments, the magnetic field generator 820 may include a plurality of solenoids 822 spaced apart a set or predetermined distance from the operating portion 830 and disposed radially about the operating portion 830.

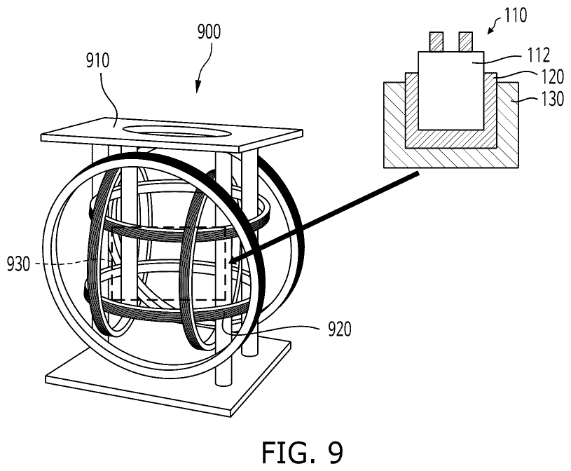

FIG. 9 illustrates an electromagnetic device 900 according to some embodiments of the present disclosure. Referring now to FIG. 9, the electromagnetic device 900 according to some embodiments of the present disclosure may replace the electromagnetic device 410 included in the electrolyte wetting apparatus 400 disclosed reference to FIG. 4A.

The electromagnetic device 900 may include: a frame 910; a magnetic field generator 920 disposed on the frame 910 and including an electromagnetic induction coil configured to generate a magnetic field; and an operating portion 930 positioned on the central portion of the frame 910 and on which the secondary battery 110, the first mold 120, and the magnetorheological fluid 130 are disposed. The frame 910 may have a magnetic field generator 920 disposed in the internal cavity thereof. The frame 910 may be formed from, for example, a metallic material, such as stainless steel, aluminum, or the like, or a combination of a metallic material and a polymer. The frame 910 may accommodate in the cavity thereof the secondary battery 110, the first mold 120, and the magnetorheological fluid 130, which are disposed on the magnetic field generator 920 and the operating portion 930.

In some embodiments, the magnetic field generator 920 may include three-axis Helmholtz coils spaced apart a set or predetermined distance from the operating portion 930.

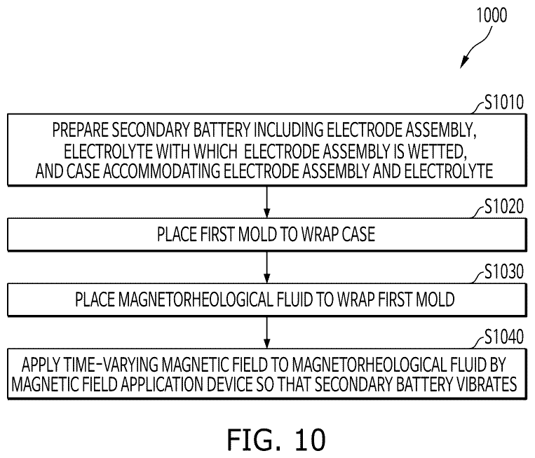

FIG. 10 illustrates a flowchart showing an electrolyte wetting method according to some embodiments of the present disclosure. Referring to FIG. 10, the electrolyte wetting method 1000 according to some embodiments of the present disclosure may begin with preparing a secondary battery including an electrode assembly, an electrolyte with which the electrode assembly is wetted, and a case accommodating the electrode assembly and electrolyte (S1010).

For example, referring to FIG. 2, in the secondary battery 110, the electrode assembly 210 and the electrolyte with which the electrode assembly 210 is wetted, may be accommodated within the case 112.

In addition, an operation of placing a first mold to wrap the case (S1020) and an operation of placing a magnetorheological fluid to wrap the first mold may be performed (S1030).

For example, referring to FIGS. 1 and 3, the first mold 120 may be configured to wrap around the case 112 of the secondary battery 110. The first mold 120 may have a receiving space with an open first end, and a portion of the case 112 of the secondary battery 110 may be inserted into the receiving space of the first mold 120. Accordingly, the first mold 120 may be configured to wrap around the case 112 of the secondary battery 110. Herein, the first mold 120 and the case 112 may be in contact with each other. The first mold 120 may be configured to be spaced apart at least a set or predetermined distance from the first electrode tab 114_1 and the second electrode tab 114_2 of the secondary battery 110 and to wrap around the case 112 of the secondary battery 110. In other words, the first mold 120 may be configured to not wrap around the first electrode tab 114_1 and the second electrode tab 114_2.

The magnetorheological fluid 130 may include a plurality of magnetic particles 132 formed from a ferromagnetic or paramagnetic material and an oil 134 in which the magnetic particles 132 are dispersed. In examples in which the external magnetic field 320 is not applied, the magnetorheological fluid 130 may flow like a fluid in a disordered state. In examples in which the external magnetic field 320 is applied, the magnetic particles 132 may align in the direction of the magnetic field 320, thereby resulting in a change in the shape or properties thereof. The magnetic particles 132 may be formed from any material having low coercivity and high saturation magnetization, such as a plurality of carbonyl iron particles (CIPs) or the like. The magnetic particles 132 may also include any ferromagnetic material, such as an iron-cobalt alloy, a nickel-zinc alloy, a ceramic alloy, or any paramagnetic material, such as iron carbonyl, magnetite, maghemite, or chromium. The magnetic particles 132 are not limited to the materials described above, and may include any ferromagnetic or paramagnetic material. The oil 134 may include at least one of a non-magnetic silicone oil or a non-magnetic mineral oil.

Thereafter, an operation of applying a time-varying magnetic field to the magnetorheological fluid by a magnetic field application device so that the secondary battery vibrates may be performed (S1040).

For example, referring to FIG. 1, the time-varying magnetic field may be applied to the magnetorheological fluid 130 by the magnetic field application device 140 to induce vibration in the secondary battery 110. Referring to FIG. 4A, the magnetic field application device 140 may be replaced by the electromagnetic device 410.

The electrolyte wetting method 1000 performed by the above-described method may be executed by, for example, each of the electrolyte wetting apparatuses 100 and 400 disclosed reference to FIG. 1 and FIG. 4A.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

What is claimed is:

1. An electrolyte wetting apparatus comprising:
a first mold configured to wrap a case of a secondary battery, an interior of the case accommodating an electrode assembly and an electrolyte that impregnates the electrode assembly;
a magnetorheological fluid configured to wrap the first mold; and
a magnetic field application device configured to apply a time-varying magnetic field to the magnetorheological fluid so that the secondary battery vibrates.

2. The electrolyte wetting apparatus as claimed in claim 1, wherein the magnetorheological fluid comprises a plurality of magnetic particles and an oil in which the magnetic particles are dispersed.

3. The electrolyte wetting apparatus as claimed in claim 2, wherein the magnetic particles comprise a plurality of carbonyl iron particles (CIPs), and
wherein the oil comprises at least one of non-magnetic silicone oil or non-magnetic mineral oil.

4. The electrolyte wetting apparatus as claimed in claim 1, wherein the magnetic field application device comprises:
a support configured to support the secondary battery, the first mold, and the magnetorheological fluid;
a permanent magnet on a side opposite the magnetorheological fluid relative to the support and configured to apply the time-varying magnetic field to the magnetorheological fluid to deform the magnetorheological fluid; and
a second mold configured to hold the permanent magnet.

5. The electrolyte wetting apparatus as claimed in claim 4, wherein the magnetic field application device further comprises a controller connected to the second mold and configured to control movement of the second mold to vary a strength or a direction of the time-varying magnetic field applied to the magnetorheological fluid.

6. The electrolyte wetting apparatus as claimed in claim 5, wherein the second mold is formed from a non-magnetic material.

7. The electrolyte wetting apparatus as claimed in claim 1, wherein the first mold is formed from a non-magnetic and non-conductive material.

8. The electrolyte wetting apparatus as claimed in claim 1, wherein the first mold is formed from an elastic material.

9. The electrolyte wetting apparatus as claimed in claim 1, wherein a surface of the first mold has a roughness at or above a set value.

10. The electrolyte wetting apparatus as claimed in claim 1, wherein the secondary battery is a pouch lithium ion secondary battery.

11. An electrolyte wetting apparatus comprising:
a first mold configured to wrap a case of a secondary battery, an interior of the case accommodating an electrode assembly and an electrolyte that impregnates the electrode assembly;
a magnetorheological fluid configured to wrap the first mold;
a magnetic field application device configured to apply a magnetic field to the magnetorheological fluid so that the secondary battery vibrates in response to deformation of the magnetorheological fluid; and
a controller connected to the magnetic field application device and configured to control current applied to the magnetic field application device to vary a strength or a direction of the magnetic field applied to the magnetorheological fluid.

12. The electrolyte wetting apparatus as claimed in claim 11, wherein the magnetic field application device comprises:
a frame;
a magnetic field generator mounted on the frame and comprising an electromagnetic induction coil configured to generate the magnetic field; and
an operating portion positioned on a central portion of the frame and on which the secondary battery, the first mold, and the magnetorheological fluid are positioned.

13. The electrolyte wetting apparatus as claimed in claim 12, wherein the magnetic field generator comprises:
a first set of solenoids comprising a plurality of first solenoids spaced apart a distance from the operating portion on a virtual plane comprising the operating portion and positioned symmetrically about the operating portion; and
a second set of solenoids comprising a plurality of second solenoids on a first side relative to the virtual plane to be directed toward the operating portion in common.

14. The electrolyte wetting apparatus as claimed in claim 12, wherein the magnetic field generator comprises:
a first set of solenoids comprising a plurality of first solenoids spaced apart a distance from the operating portion and on opposite sides of the operating portion in a first direction; and
a second set of solenoids comprising a plurality of second solenoids spaced apart a distance from the operating portion and on opposite sides of the operating portion in a second direction different from the first direction.

15. The electrolyte wetting apparatus as claimed in claim 12, wherein the magnetic field generator comprises:
a first set of solenoids comprising a plurality of first solenoids positioned on a first side relative to a virtual plane comprising the operating portion and directed toward the operating portion in common; and
a second set of solenoids comprising a plurality of second solenoids positioned on a second side relative to the virtual plane and directed toward the operating portion in common.

16. The electrolyte wetting apparatus as claimed in claim 12, wherein the magnetic field generator comprises a plurality of solenoids spaced apart a distance from the operating portion and positioned radially about the operating portion.

17. The electrolyte wetting apparatus as claimed in claim 12, wherein the magnetic field generator comprises three-axis Helmholtz coils spaced apart a distance from the operating portion.

18. The electrolyte wetting apparatus as claimed in claim 11, wherein the first mold is formed from a non-magnetic and non-conductive material.

19. The electrolyte wetting apparatus as claimed in claim 11, wherein a surface of the first mold has a roughness at or above a set value.

20. The electrolyte wetting apparatus as claimed in claim 11, wherein the magnetorheological fluid comprises a plurality of magnetic particles and an oil in which the magnetic particles are dispersed.
